(19) United States
(12) Patent Application Publication
(10) Pub. No.: US 2007/0158476 A1
(43) Pub. Date: Jul. 12, 2007

(54) Nozzle arrangements

(76) Inventors: Keith Laidler, West Midlands (GB); Rajab Sharief, Manchester (GB); Hassan Abduljalil, Manchester (GB)

Correspondence Address: PEARSON & PEARSON, LLP, 10 GEORGE STREET, LOWELL, MA, 01852, US

(21) Appl. No.: 10/561,687

(22) PCT Filed: Jul. 2, 2004
(86) PCT No.: PCT/GB04/02851

§ 371 Date: Jan. 4, 2007

(30) Foreign Application Priority Data
Jul. 4, 2003 (GB) 0315664.3

(51) Int. Cl. A62C 37/20; B05B 1/30; A62C 31/02

(52) U.S. Cl. 239/589; 239/569; 239/562

(57) ABSTRACT

A nozzle arrangement comprises a body (10) of two parts (11), (12) which define between them a fluid passage (15), leading to a discharge outlet (25), from a feed passage (17). The passageway contains a chamber (19) wherein is located a flap member (20) which can be displaced by increased pressure of fluid flow in the passageway to variably obstruct an outlet orifice (21). This may be achieved by the cooperation of holes or notches in the displaceable flap member and corresponding apertures or notches in a fixed member.

The present invention relates to nozzle arrangements. More particularly, but not exclusively, the present invention relates to nozzle arrangements that are adapted to generate a spray of a fluid, which is forced to flow through the nozzle arrangement under pressure.

Nozzles are often used to provide a means of generating sprays of various fluids. In particular, nozzles are commonly fitted to the outlet valves of pressurised fluid-filled containers, such as so-called “aerosol canisters”, to provide a means by the fluid stored in the container can be dispensed in the form of a spray or mist. A large number of commercial products are presented to consumers in this form, including, for example, antiperspirant sprays, deodorant sprays, perfumes, air fresheners, antiseptics, paints, insecticides, polish, hair care products, pharmaceuticals, water and lubricants. In addition, pump or trigger-actuated nozzle arrangements, i.e. arrangements where the release of fluid from a non-pressurised container is actuated by the operation of a manually operable pump or trigger that forms an integral part of the arrangement, are also frequently used to generate a spray or mist of certain fluid products. Examples of products that typically incorporate pump or trigger nozzle devices include various lotions, insecticides, as well as various garden and household sprays.

A spray is generated when a fluid is caused to flow through a nozzle arrangement under pressure. To achieve this effect, the nozzle arrangement is configured to cause the fluid stream passing through the nozzle to break up or “atomise” into numerous droplets, which are then ejected through an outlet of the arrangement in the form of a spray or mist.

The optimum size of the droplets required in a particular spray depends primarily on the particular product concerned and the application for which it is intended. For example, a pharmaceutical spray that contains a drug intended to be inhaled by a patient (e.g. an asthmatic patient) usually requires very small droplets, which can penetrate deep into the lungs. In contrast, a polish spray preferably comprises spray droplets with larger diameters to promote the impaction of the aerosol droplets on the surface that is to be polished and, particularly if the spray is toxic, to reduce the extent of inhalation.

The size of the aerosol droplets produced by such conventional nozzle arrangements is dictated by a number of factors, including the dimensions of the outlet orifice and the pressure with which the fluid is forced through the nozzle. However, problems can arise if it is desired to produce a spray that comprises small droplets with narrow droplet size distributions, particularly at low pressures. The use of low pressures for generating sprays is becoming increasingly desirable because it enables low pressure nozzle devices, such as the manually-operable pump or trigger sprays, to be used instead of more expensive pressurised containers and, in the case of the pressurised fluid-filled containers, it enables the quantity of propellant present in the spray to be reduced, or alternative propellants which typically produce lower pressures (e.g. compressed gas) to be used. The desire to reduce the level of propellant used in aerosol canisters is a topical issue at the moment and is likely to become more important in the future due to legislation planned in certain countries, which proposes to impose restrictions on the amount of propellant that can be used in hand-held aerosol canisters. The reduction in the level of propellant causes a reduction in the pressure available to drive the fluid through the nozzle arrangement and also results in less propellant being present in the mixture to assist with the droplet break up. Therefore, there is a requirement for a nozzle arrangement that is capable of producing an aerosol spray composed of suitably small droplets at low pressures.

A further problem with known pressurised aerosol canisters fitted with conventional nozzle arrangements is that the size of the aerosol droplets generated tends to increase during the lifetime of the aerosol canister, particularly towards the end of the canisters life as the pressure within the canister reduces as the propellant becomes gradually depleted. This reduction in pressure causes an observable increase in the size of the aerosol droplets generated and thus, the quality of the spray produced is compromised.

Accordingly, it is an object of the present invention to provide a nozzle arrangement that is adapted to generally reduce the size of the droplets generated when compared with conventional nozzle devices, as well as reduce the droplet size distributions. In addition, it is an object of the present invention to provide a nozzle arrangement that is adapted to enable small droplets of fluid to be generated at low pressures, i.e. when fluids containing reduced or depleted levels of propellant, or a relatively low-pressure propellant such as compressed gas, is used, or a low-pressure system is used, such as a pump- or trigger-actuated nozzle arrangement.

The problem of providing a high quality spray at low pressures is further exacerbated if the fluid concerned has a high viscosity because it becomes harder to atomise the fluid into sufficiently small droplets.

Accordingly, it is a further object of the present invention to provide a nozzle arrangement that is capable of generating a spray from a viscous fluid at low pressures.

A further problem associated with known nozzle arrangements is that certain products have a tendency to block or clog the spray orifices provided in the nozzle arrangement. International Patent Publication Numbers WO 01/89958 and WO 97/31841 both describe cleanable nozzle arrangements, which can be slit apart to expose the internal fluid flow passageway for cleaning. However, it is not practicable to clean the spray orifices after each individual use, which may be necessary with some products that are particularly prone to clogging the nozzle arrangement. As a consequence, the spray orifices present at the outlet of the nozzle arrangement or within the nozzle can become blocked or clogged with such products, which can adversely affect the performance of the nozzle arrangements and thus, the quality of the spray produced.

Hence, it is a further object of the present invention to provide a nozzle arrangement in which the occurrence of blockages at spray orifices is obviated or at least substantially minimised.

In the case of nozzles fitted to pressurised aerosol canisters, there is also a tendency for the fluid flow through the nozzle to reduce as the contents present in the canister become depleted. As previously indicated, this is primarily due to the depletion of the propellant present in the canister and can be particularly undesirable because it results in the quality of the spray produced by the nozzle arrangement being compromised as the canister approaches the end of its operational lifetime.

For this reason, it is a further object of the present invention to means by which the level of fluid flow through a nozzle arrangement can be maintained at a constant or substantially constant level.

According to the present invention there is provided a nozzle arrangement adapted to be fitted to an outlet of a fluid supply and to generate a spray of fluid dispensed from said fluid supply during use, said nozzle arrangement having a body which comprises:
(i) actuator means which is adapted, upon operation, to cause fluid to flow from said fluid supply into said nozzle arrangement;
(ii) an inlet through which fluid from said fluid supply accesses the nozzle arrangement during use;
(iii) one or more outlet orifices through which fluid is ejected from the nozzle arrangement during use; and
(iv) an internal fluid flow passageway which connects said inlet to said one or more outlet orifices;

wherein said internal fluid flow passageway comprises a first orifice-defining portion and a flap having a second orifice-defining portion, said flap being configured to be displaced by the flow of fluid through the internal passageway during use from a first position, in which said flap resides when the nozzle arrangement is not in use and wherein the first and second orifice-defining portions are disposed apart from one another, to a second position, in which said first and second orifice-defining portions are disposed proximate to one another and together define an orifice through which the fluid passing through the nozzle arrangement must pass.

The parts of a nozzle arrangement most likely to become clogged with matter during use are the narrow/constricted portions, such as internal or external orifices. For this reason, the provision of an orifice defined by two (or more) orifice-defining portions, at least one of which is provided on a moveable flap so that it is in its orifice-defining position when the nozzle arrangement is in use (i.e. when fluid is flowing through the nozzle arrangement), but can move away when the nozzle arrangement is not in use to provide a means by which any matter that has become lodged at the orifice can be dislodged. In effect, the orifices are self-cleaning and the build up of residue at the orifices of a nozzle arrangement is dramatically reduced.

Preferably, the first orifice-defining portion is a portion of the body of the nozzle arrangement which defines the internal fluid flow passageway. Preferably, the first orifice-defining portion is in the form of a recess or internal wall, which is adapted to receive the second orifice-defining portion of the flap when it is displaced into the second “orifice-forming” position. The flap may be connected to the side of the fluid flow passageway or, more preferably, it may be positioned within a recess of the chamber wall.

The flap may be connected to the body by a resilient mounting which permits the flap to move from the first position to the second “orifice-defining” position by the pressure of fluid flowing through the internal passageway. Once the fluid flow ceases, the resilient mounting causes the flap to return to the first position, thereby dislodging any residue that may have become lodged in the orifice. More preferably, the flap is itself resiliently deformable and is caused to bend from the first position to the second position by the flow of fluid through the nozzle arrangement, and then return to the first position once the fluid flow ceases.

The second orifice-defining portion of the flap is preferably a freely moveable end of the flap. Alternatively, the second orifice-defining portion may be a semi-circular or otherwise shaped cut-out portion which, together with the first orifice-defining portion forms the orifice when the flap abuts the first orifice-defining portion.

The orifice-defining portions may define more than one orifice. Furthermore, the orifice, once formed, may be positioned upstream from an expansion chamber so as to form an orifice through which fluid can be sprayed into the chamber.

The size of the orifice may vary depending on the pressure with which the fluid is forced through. For example, at high pressures the orifice may be small because the flap is urged into close contact with first orifice-defining portion of the body. At reduced pressures, however, the resilience of the flap may cause it to be further displaced from the first orifice-defining portion of the body.

The orifice(s) defined by the flap may be of any shape, for example circular, square, oblong etc.

The flap may form a flow control mechanism and be resiliently deformable so that it can be displaced from a first position in which the passageway is fully open to a second position in which the flap extends into and constricts the passageway in response to the pressure of the fluid flowing through the passageway during use, and return to the first position when the actuation ceases and the nozzle arrangement is not in use.

The flap may be configured so that the extent of displacement between said first and second positions is dependent on the pressure with which the fluid flows through the nozzle arrangement. Therefore, the extent to which the passageway is constricted depends principally on the fluid pressure, i.e. as the pressure reduces, the displacement of the flap is less and, as a consequence, the constriction of the passageway is less so that the fluid flow remains substantially the same as when the pressure is higher and the flap constricts the passageway to a greater extent.

Alternatively, the flap may be configured to displace to its fullest extent once a predetermined minimum threshold pressure is exceeded. For example, the flap could be configured so that displaces fully at pressures above 4 bars. Therefore, when an aerosol canister equipped with the nozzle arrangement is full and the pressure generated is typically between 4 and 7 bars, the flap will be urged towards the second position by the fluid flow through the passageway and thus, the orifice of the passageway will be constricted by the flap. However, as the pressure in the aerosol canister reduces with use (i.e. as the propellant becomes depleted), the flap will return to the first position when the pressure falls below 4 bars. This will cause the passageway to open and thus, increase the fluid flow at lower pressures. This approach is anticipated to enable the fluid flow to be maintained within 25% throughout the lifetime of the aerosol canister.

The flap preferably extends vertically within the passageway, although it may also extend horizontally.

In an alternative embodiment, the flap is displaced into a tapered recess and the gap between the end of the flap received in the recess and the wall of the recess defines the aperture through which fluid may flow. A high pressures urges the flap further into the tapered recess where the gap between the flap and the tapered recess wall is smallest, whereas the size of the gap increases as the pressure reduces and the resilience of the flap causes it to be urged away from the tapered recess back towards the first position. This results in a larger gap between the recess and the end of the flap being provided at lower pressures and thus, enables the volume of fluid flow through the passageway to be maintained within the desired ranges and also be virtually independent from pressure changes that may occur.

The fluid supply may be any suitable fluid supply to which a nozzle arrangement is usually attached. In most cases the fluid supply will be container, such as pressurised hand-held aerosol canister.

The nozzle arrangements of the present invention are preferably formed from plastic.

It is also preferable that the body of the nozzle arrangements of the present invention is composed of at least two interconnected parts. Each part preferably has an abutment surface, which may be brought into contact with one another to form the final nozzle arrangement assembly. One or more of the abutment surfaces preferably comprise grooves and recesses formed thereon which, when the surfaces are brought into contact, define the fluid flow passageway (including any chambers positioned along its length), as well as the outlet and, optionally, the inlet. Preferably, a seal is provided between the abutment surfaces, which prevents fluid passing through the nozzle arrangement from leaking out between the abutment surfaces during use. This construction is preferred because it can be manufactured very cheaply and with a high degree of precision. In addition, the constituent parts of the body may be permanently fixed together to form the final, assembled nozzle arrangement or, alternatively, the parts may remain separable so that fluid flow passageway may be opened and exposed for cleaning. Most preferably, the nozzle arrangement is formed of two parts interconnected by a hinge so as to enable the respective parts to be moved towards or away from each other to enable cleaning to be effected.

Nozzle arrangements of this construction are described further in WO 01/89958 and WO 97/31841, the entire contents of which are incorporated herein by reference.

The actuator means may be any suitable actuator means that is capable of initiating the flow of fluid through the nozzle arrangement. Various means are well known in the art. For example, nozzle arrangements fitted to pressurised fluid-filled canisters typically comprise and actuator that can be depressed so as to engage and open the outlet valve of the canister and thereby permit the fluid stored therein to be dispensed through the nozzle arrangement. In addition, pump and trigger nozzle arrangements are widely available as a means for dispensing fluids from non-pressurised containers. In these cases, the operation of the pump or trigger generates the pressure, which causes the fluid from the container to be dispensed through the nozzle arrangement.

How the invention may be put into practice will now be described in more detail in reference to the following Figures, in which:

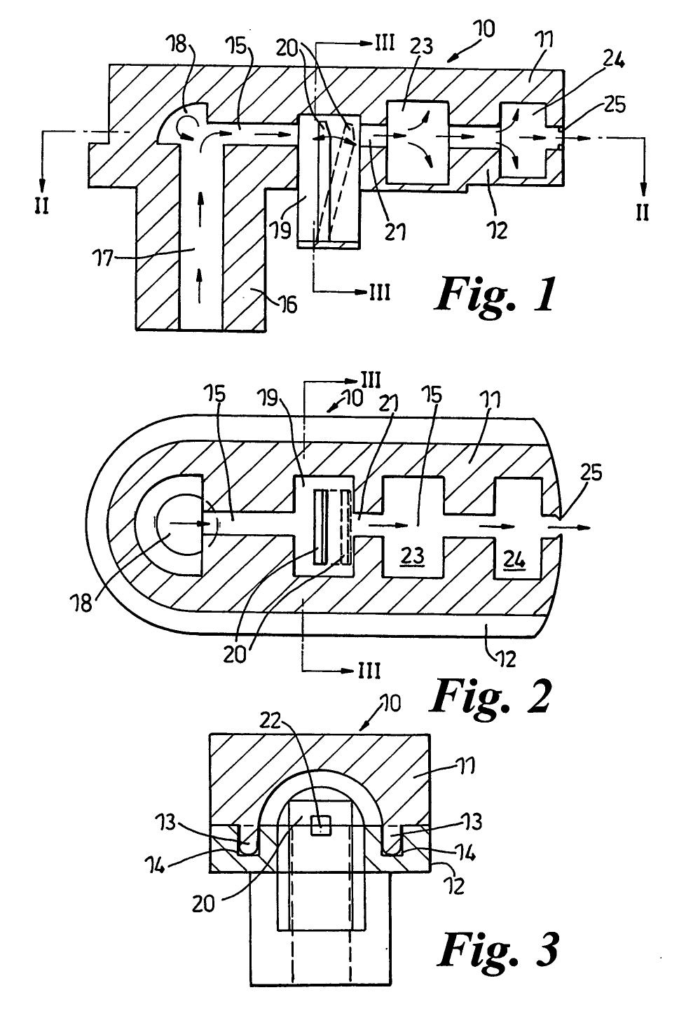

FIG. 1 is a diagrammatic cross-sectional view of a nozzle arrangement according to the invention;

FIG. 2 is a sectional view on line II-II of FIG. 1;

FIG. 3 is a sectional view on line III-III of FIG. 1;

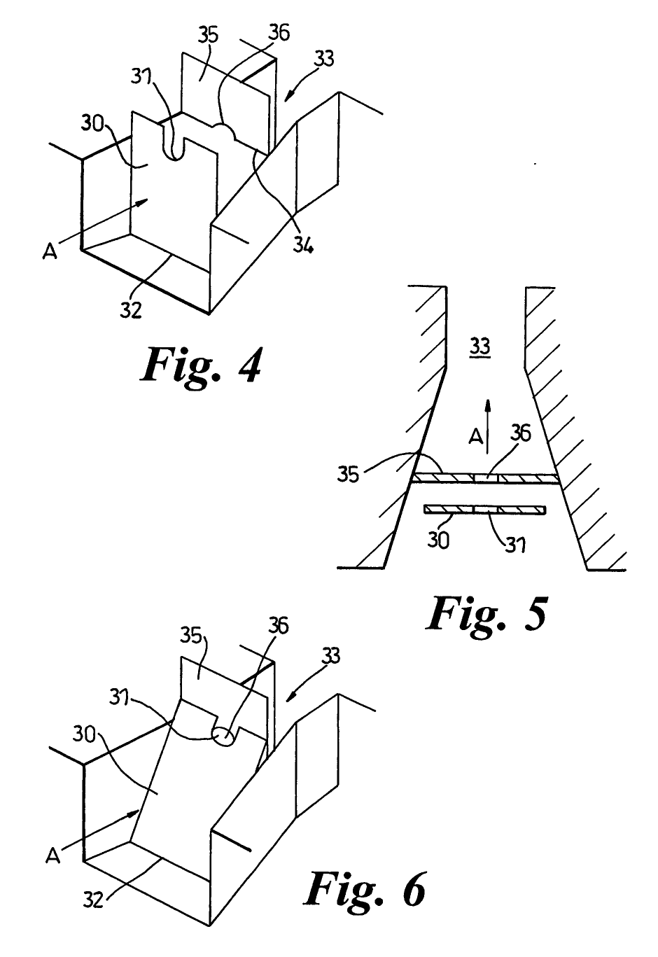

FIG. 4 is a perspective diagrammatic view of a first embodiment of flap valve member used in the nozzle arrangement according to the invention;

FIG. 5 is a diagrammatic sectional plan view of the flap valve of FIG. 4;

FIG. 6 is a view similar to FIG. 4 showing the flap displaced when subjected to fluid pressure;

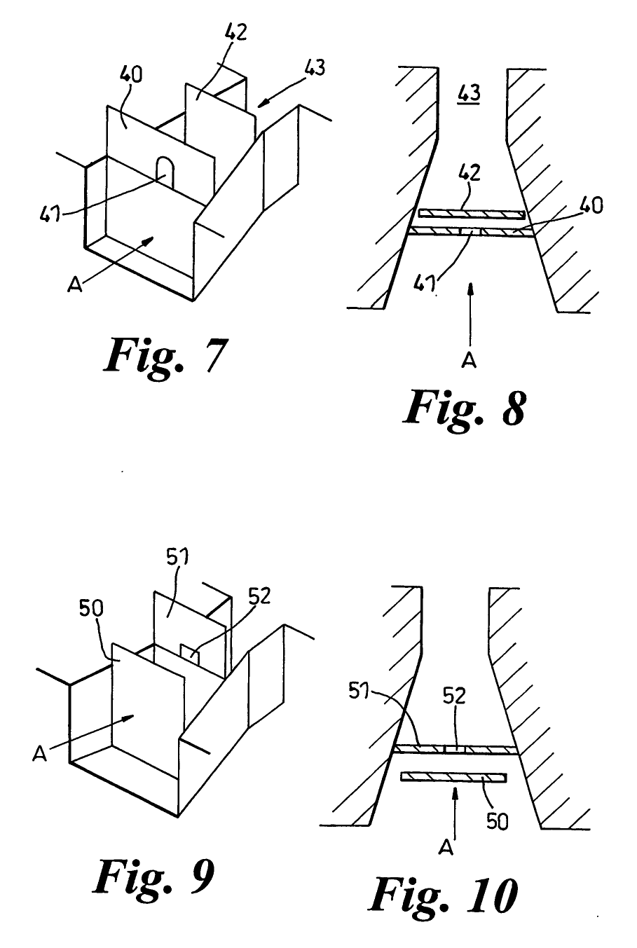

FIG. 7 is a view similar to FIG. 4 of a further embodiment of flap valve;

FIG. 8 is a view similar to FIG. 5 thereof;

FIG. 9 is a view similar to FIG. 4 of a third embodiment of flap valve;

FIG. 10 is a view similar to FIG. 5 thereof;

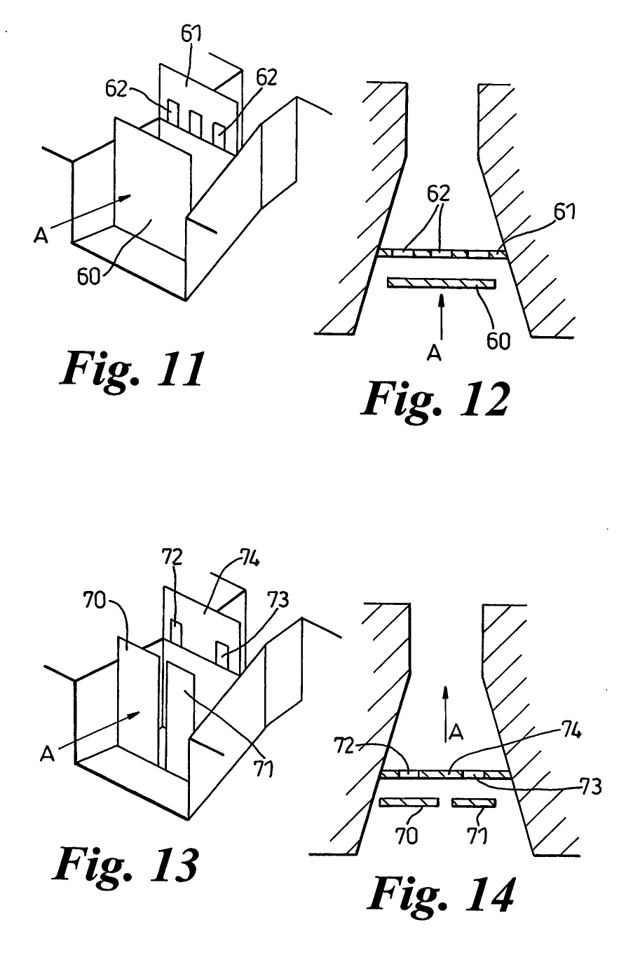

FIG. 11 is a view similar to FIG. 4 of a further embodiment of flap valve;

FIG. 12 is a view similar to FIG. 5 thereof;

FIG. 13 is a view similar to FIG. 4 of a fifth embodiment of flap valve.

FIG. 14 is a view similar to FIG. 5 thereof;

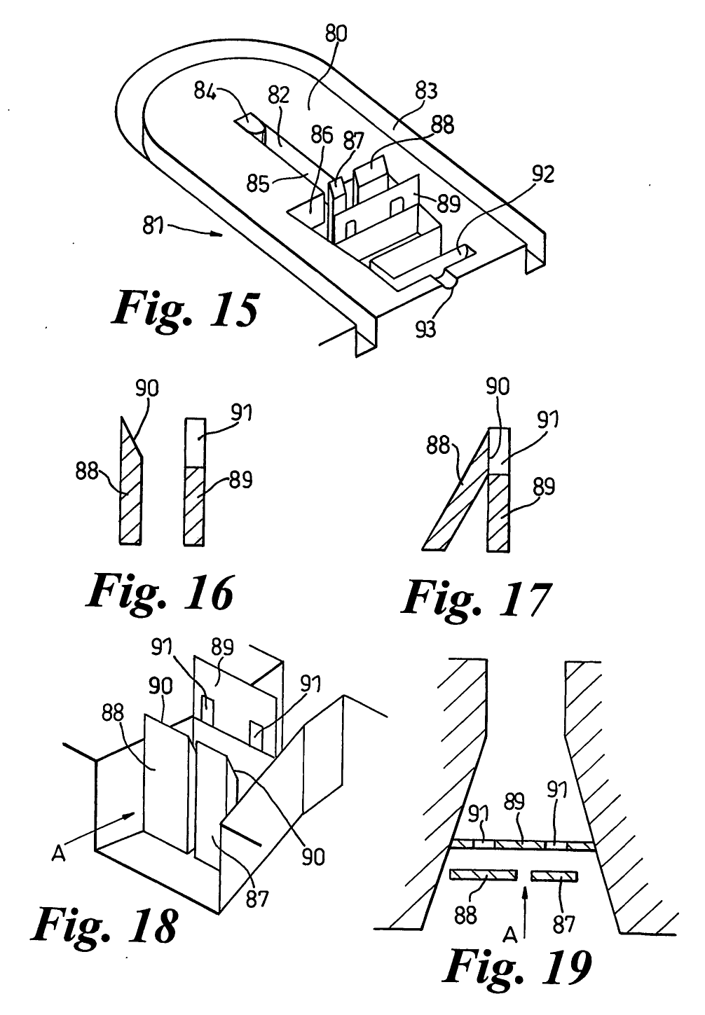

FIG. 15 is a perspective view of the abutment surface of one part of a further nozzle arrangement according to the invention;

FIG. 16 is a diagram showing the portion of a flap valve thereon when open and

FIG. 17 shows the same flap valve when closed;

FIG. 18 is a perspective view similar to FIG. 4 of the flap valve provided in the FIG. 15 nozzle arrangement;

FIG. 19 is a view similar to FIG. 5 of the same flap valve;

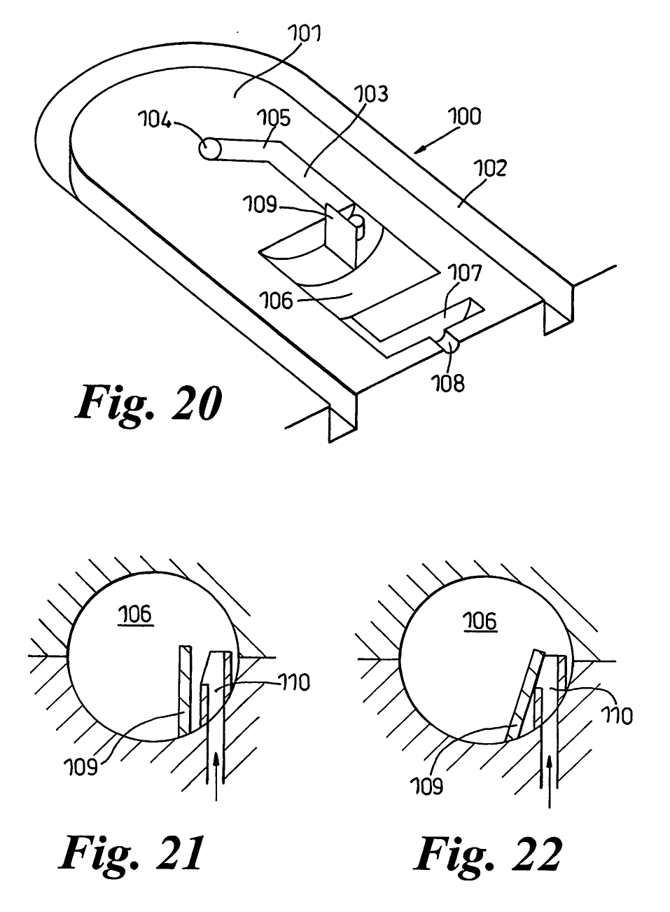

FIG. 20 is a view similar to FIG. 15 of one part of a yet further nozzle arrangement according to the invention;

FIG. 21 is a diagrammatic cross-section of the flap valve used in the FIG. 20 embodiment, in open position; and

FIG. 22 is a similar view showing the flap valve in closed position;

FIG. 23 is a view similar to FIGS. 15 and 20 of a part of a further nozzle arrangement according to the invention;

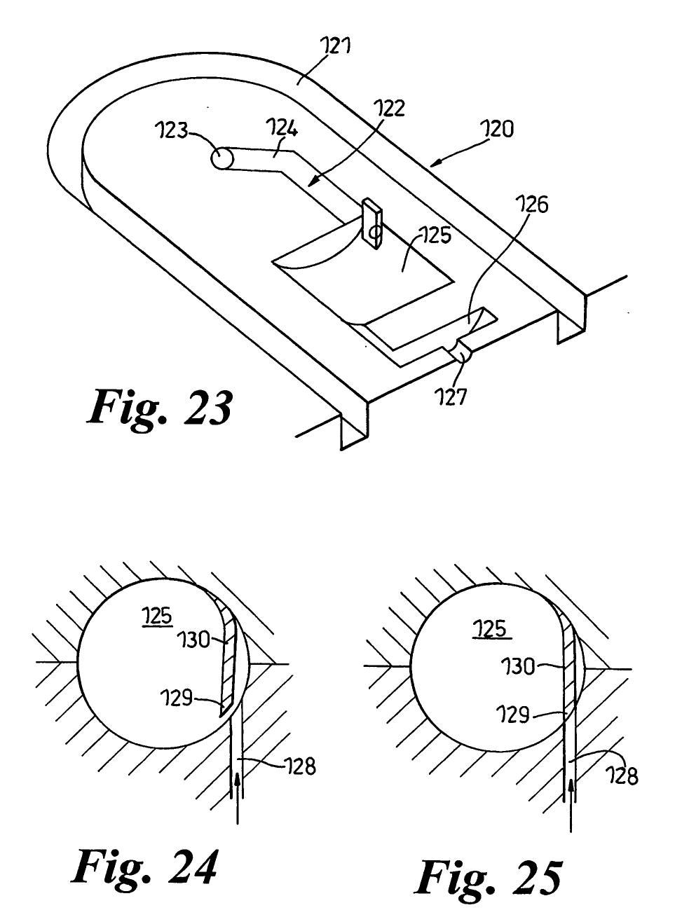

FIG. 24 is a sectional view showing the flap valve used in the FIG. 23 embodiment in open position, and

FIG. 25 is a similar view showing the flap valve in closed position;

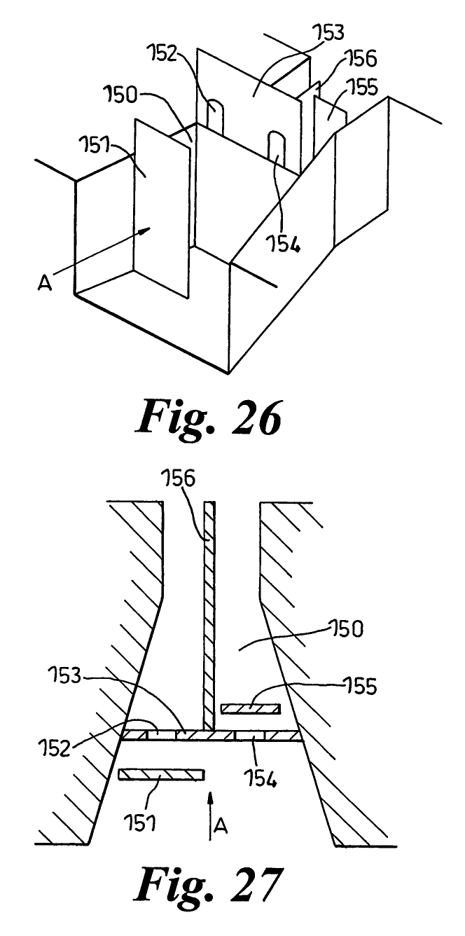

FIG. 26 is a view similar to FIG. 4 of a further flap valve for use in the invention; and

FIG. 27 is a view similar to FIG. 5 of the further flap valve of FIG. 26.

The drawings show an embodiment of nozzle arrangement 10 according to the invention, which is adapted to be fitted to an outlet of a fluid supply such as a spray can body or other such dispenser, to generate a spray of fluid dispensed from the fluid supply during use. The nozzle arrangement includes an actuator, not shown in the drawings to cause fluid to flow from the fluid supply with the nozzle arrangement.

The nozzle arrangement 10 in FIGS. 1 to 3 comprises a two-part body having an upper part 11 and a lower part 12. The parts are mutually located and sealed together by means of a rib 13 formed on the upper part 11 which engages in a groove 14 formed on the lower part 12 (see FIG. 3). A flow passage 15 is provided within the body of the nozzle arrangement, and this is defined by matching voids in the abutting faces of the upper and lower parts.

Fluid from the fluid supply is fed through a tube 16, having a passage 17, to enter the nozzle passage 15 at a widened end part thereof, 18 which may constitute an expansion chamber or vestibule.

The direction of fluid flow within the nozzle arrangement 10 is from left to right, allowing the arrows, as shown in FIGS. 1 and 2.

The fluid after leaving the vestibule 18 flows along a section of passage 15 to enter a chamber 19. Chamber 19 comprises a widened and enlarged space relative to the passage 15, and contains a resilient flap number 20 which is movable, about a lower edge pivot, between an open position, shown in fill lines in FIGS. 1 and 2 and a closed portion where it serves to obstruct an outlet 21 leading to a further section of the passage 15. The flap member 20 serves to obstruct the outlet 21 in the sense that the latter may when in the closed (broken line) position block the outlet 21 completely, or by bringing an aperture 22 in the flap member 20 into full or partial register with the aperture 22 permit only a flow having a reduced cross-sectional area with respect of the full aperture of the outlet 21, or have the flap with no aperture only partially cover the outlet 21 thereby introducing a constriction into the passage 15. In an alternative embodiment, the upper edge of the flap member 20 may be provided with a notch in place of the aperture 22.

The flap 20 operates as a flow controller. When the pressure impelling the fluid is high, the flap is pushed towards the closed broken line position, thereby then reducing the effective size of the outlet 21. At lower pressures, the flap resists bending more effectively and the effective size of the outlet 21 is virtually the full area of the outlet. For example, when an aerosol or compressed gas spray is used, the flap could be pressed to maximum obstruction when the dispenser is full with pressure from 7 down to 4 Bar, and then gradually move to the left (full line position) as pressure reduces during life of the spray. The outlet size will after initial release remain effectively constant.

After exiting the outlet 21, the fluid passes through further chambers 23 and 24 before passing to a final spray outlet 25 to exit the nozzle assembly. The chambers 23 and/or 24 may be configured to provide an expansion chamber and/or swirl chamber, or a venturi and include converging surfaces or constrictions as connected appropriate to provide the required droplet sizes and other spray characteristics.

Various embodiments of flap devices for use in nozzle arrangements in accordance with the invention, and some modified nozzle arrangements are described with reference to FIGS. 4 to 27 of the drawings. It should be noted that these drawings are diagrammatic and for example clearances between flaps and the sides of passages may be shown for clarity. In practice the flap and for the passage wall is shaped to ensure a proper fit.

Firstly, FIGS. 4 to 7 show a basic simple form of flap valve, comprising a flap 30, which has a notch 31 formed in its upper edge, and is pivotable about its lower edge 32 in response to fluid pressure acting in the direction of arrow A. The flap 30 is mounted in a converging passage or throat 33 and is arranged when deflected to rest against the lower edge 34 of a fixed fence or bridge 35 with a notch 36 in its lower edge. FIGS. 4 to 6 have no wall below the fence and are designed for self-cleaning, while FIG. 7 has a wall 44 and is designed for flow control. The maximum deflection closed position of flap 30 is shown in FIG. 7.

The effect of deflection of the flap 30 towards the member 35 is to decrease the flow cross-section of the aperture of the passage 33 until a minimum cross-section representing the unobstructed area of the notches 31 and 36 remaining on the FIG. 7 positions is attained.

FIGS. 7 and 8 similarly illustrate a modified embodiment where a fence or bridge member 40 over a wall 44 with a notch 41 in its lower edge, is located upstream of a flap 42, instead of downstream thereof. The flap 42 is un-notched and provides maximum obstruction of the passageway 43 at low pressures, so that increasing fluid pressure will tend to open the orifice as the flap is deflected, which is effective to restrict back flow, making this a one-way valve.

FIGS. 9 and 10 similarly illustrate a further embodiment of flap valve 50, which differs from FIGS. 4 and 5 in that flap 50 has no notch or aperture, and in that the bridge or fence member 51 is provided with a squared notch 52 rather than an arched notch.

FIGS. 11 and 12 shown a variant of flap valve wherein again the flap 60 is unnotched or apertured, whilst the bridge or fence member 61 is formed with an array of three notches 62 in its lower edge.

FIGS. 13 and 14 show a yet further variant embodiment wherein two flaps 70, 71 are located side by side, and each cooperate with an associated notch 72, 73 on the lower edge of bridge or fence member 74. The flaps 70, 71 may have different characteristics such as flexibility so that e.g. flap 70 will obstruct notch 72 before flap 1 begins to deflect in response to increased pressure. This will give greater flow control so that instead of a single on/off valve, there are a plurality which operate at different pressures.

In FIG. 15 is shown an abutment surface 80 of a part 81 of a second embodiment of nozzle arrangement according to the invention. It will be understood that the other part thereof (not shown) matches the part shown to define a flow passage 82 therethrough. The surface 80 includes a groove 83 therearound which will cooperate with a corresponding rib on the said other part. The flow passage 82 comprises an inlet 84 where fluid from a reservoir is introduced to the nozzle arrangement, and a straight section 85 leading to an expansion chamber 86 in which is located a flap arrangement, comprising two flap members 87, 88 and a bridge or fence member 89, this arrangement being similar to that shown in FIGS. 13 and 14. The flap members 87, 88 have (as would in fact be usually the case) sloped or bevelled upper edges 90 which cooperate with notches or apertures 91 in the fence member 89 as shown for example in FIGS. 16 and 17 to obstruct the notches 91 when closed.

The passageway 82 then leads from chamber 86 via a swirl chamber 92 to a spray outlet 93.

FIG. 20 again shows a part 100 with an abutment surface 101 adapted to form a nozzle arrangement according to the invention with a corresponding part. Part 100 has a circumferential groove 102 which receives a corresponding rib on the other part, and the two parts define a flow passage 103 which comprises an inlet 104, a dogleg passage 105, an expansion chamber 106 and a swirl chamber 107 leading to a spray outlet 108. In accordance with the invention, the inlet to the chamber 106 is controlled by a flap member 109, which is disposed to control the inlet of a tangential inlet tube 110 by deflection of the flap member 109 in response to the fluid pressure obtaining in the chamber 106. This is shown in FIGS. 21 and 22, wherein the outlet of tube 110 is shown as having a sloped edge such that all of the outlet can be obstructed by the flap 109 in the closed FIG. 22 position.

This arrangement is sensitive to back-pressure surges which might occur downstream of the flap valve due to causes such as blockage of the outlet 108, and provides a one-way valve to prevent a second liquor or gas going down the tangential input orifice.

FIGS. 23 to 25 illustrate a further embodiment of nozzle arrangement according to the invention. FIG. 23 shows one part 120 of a two part nozzle arrangement, the other complementary part of which is not shown. A circumferential groove 121 is provided to engage with a complementary rib on the said other part. The parts define between them a flow passageway 122 which includes an inlet 123, a dogleg section 124, an expansion chamber 125, a swirl chamber 126 and a spray outlet 127.

The chamber 125 has a tangential inlet conduit 128 which cooperates with the levelled face end 129 of a flap member 130 which is resiliently adhered to the inner surface of the chamber 125. The flap member responds to pressure in the chamber 125 to vary the obstruction of the orifice of conduit 128, between closed as in FIG. 28 and an open condition as in FIG. 24. This again provides a one-way valve which prevents back-flow.

A final embodiment of flap arrangement is shown in FIGS. 26 and 27 which are diagrams similar to FIGS. 4 and 5. The passage 150 contains a first upstream flap 151, adapted to be deflected to variably close a notch 152 in a fence member 153 in response to increased upstream feed pressure to provide a one-way valve. The fence member 153 also has a further notch or aperture 154, which is not aligned with flap 151, but is instead associated with a second flap 155 downstream of the fence member 153. The flap 155 is adapted to obstruct the further notch 154 at low pressure, and be deflected in the valve opening sense to the downstream side to thereby widen the flow passage in response to an increase of upstream pressure. The passage 150 is divided into two separate streams, by a partition 156 which separates the stream into one stream controlled by the flap 151, and another controlled by the flap 155. This will allow one stream or the other to be opened as pressure decreases or increases past a threshold to for example allow alternating feeds to alternative flow paths.

The FIGS. 4 and 5 embodiment in particular enables a nozzle arrangement to be self-cleaning. A variety of shapes of flap including curved flaps cooperating with curved wall are possible.

In the case where liquor and gas are mixed upstream of the valve the flap may vibrate and generate a sound wave which will at an appropriate frequency be effective in finely dividing the fluid droplets. This is caused by “hunting” as the pressure/back pressure fluctuates around a mean valve. The sound wave is preferably at an ultrasonic frequency and is similar to a woodwind reed.

The nozzle arrangement, is in each embodiment, preferably a hinged two-part assembly, of plastics material but nozzles according to the invention may also be fabricated in metal, or be multi-part, or comprise a nozzle with inserts.

Nozzle arrangements of the invention may also be provided which have at least two different routes for fluid, either embodying a by-pass, or providing for feed of two different fluids, usually a liquid and a gas, or two liquids, and in such cases the flap arrangement will be provided to stop back-flow from one or both of the fluids.

1. A nozzle arrangement adapted to be fitted to an outlet of a fluid supply and to generate a spray of fluid dispensed from said fluid supply during use, said nozzle arrangement having a body which comprises:
(a) actuator means which is adapted, upon operation, to cause fluid to flow from said fluid supply into said nozzle arrangement;
(b) an inlet through which fluid from said fluid supply accesses the nozzle arrangement during use;
(c) one or more outlet orifices through which fluid is ejected from the nozzle arrangement during use; and
(d) an internal fluid flow passageway which connects said inlet to said one or more orifices;
wherein said internal fluid flow passageway comprises a first orifice-defining portion, and a flap having a second orifice-defining portion, said flap being configured to be displaced by the flow of fluid through the internal passageway during use from a first position, in which said flap resides when the nozzle arrangement is not in use and wherein the first and second orifice-defining portions are disposed apart from one another, to a second position, in which said first and second orifice-defining portions are disposed proximate to one another amd together define an orifice through which the fluid passing through the nozzle arrangement must pass.

2. A nozzle arrangement according to claim 1, wherein the first orifice-defining portion is a portion of the body of the nozzle arrangement which defines the internal fluid flow passageway and is in the form of a recess or internal wall which is adapted to receive the second orifice-defining portion of the flap when it is displaced into the second, orifice forming, position.

3. A nozzle arrangement according to claim 2 wherein the flap is connected to the side of the fluid flow passageway.

4. A nozzle arrangement according to claim 1 wherein the flap is position within a recess of the chamber wall.

5. A nozzle arrangement according to claim 1 wherein the flap is connected to the body by a resilient mounting which permits the flap to move from the first position to the second, orifice defining, position by the pressure of fluid flowing through the internal passageway.

6. A nozzle according to claim 1 wherein the flap is itself resiliently deformable and is caused to bend from the first position to the second position by the flow of fluid through the nozzle arrangement, and then return to the first position once the fluid flow ceases.

7. A nozzle arrangement according to claim 1 wherein the second orifice defining portion of the flap is a freely moveable end of the flap.

8. A nozzle arrangement according to claim 1 wherein the second orifice defining portion is a semi-circular or otherwise shaped cut out portion or notch which together with the first orifice defining portion forms the orifice when the flap abuts the first orifice-defining portion.

9. A nozzle arrangement according to claim 7 wherein the orifice defining portions define more than one orifice.

10. A nozzle arrangement according to claim 1 wherein the size of the orifice is variable depending upon the pressure with which the fluid is forced through, reducing as higher pressures are applied.

11. A nozzle arrangement according to claim 1 wherein the flap forms a flow control mechanism and is resiliently deformable so that it can be displaced from a first position in which the passageway is fully open to a second position in which the flap extends into and constricts the passageway in response to the pressure of the fluid flowing through the passageway during use, and return to the first position when the actuation ceases and the nozzle arrangement is not in use.

12. A nozzle arrangement according to claim 11, wherein the flap is configured so that the extent of its placement between the first and second positions is dependent upon the pressure with which the fluid flows through the nozzle arrangement.

13. A nozzle arrangement according to claim 11, wherein the flap is configured to displace to its fullest extent once a predetermined minimum threshold pressure is exceeded.

14. A nozzle arrangement according to claim 1 wherein the flap is displaced into a tapered recess and the gap between the end of the flap that is received in the recess, and the wall of the recess defines the aperture through which fluid may flow.

15. A nozzle arrangement according to claim 1 wherein the orifice once formed is positioned upstream from an expansion chamber so as to form an orifice through which fluid can be sprayed into the chamber.

16. A nozzle arrangement according to claim 1 wherein the body is composed of at least two interconnected parts, each part having an abutment surface, and grooves and recesses formed thereon which define the fluid flow passageway, and the parts are interconnected by a hinge to enable the parts to be moved towards or away from each other to enable cleaning to be effected.

17. A nozzle arrangement according to claim 1 wherein two or more flaps are located in the passageway.

18. A nozzle arrangement according to claim 17 wherein said two or more flaps are arranged to access alternative flow passages.

19. A nozzle arrangement according to claim 17 wherein said two or more flaps provide for enhanced flow control.

20. A nozzle arrangement according to claim 1 wherein the flap member is disposed downstream of the outlet orifice, and is effective to prevent back-flow of a second fluid which is mixed with a first downstream of the flap member.

21. A nozzle arrangement according to claim 1 wherein the flap member is caused to vibrate by gas or liquor in a single or dual route nozzle to generate a sound signal to thereby break-up droplets.

22. A nozzle arrangement according to claim 2 wherein the flap is position within a recess of the chamber wall.

23. A nozzle arrangement according to claim 8 wherein the orifice defining portions define more than one orifice.
